(19) United States
(12) Patent Application Publication
(10) Pub. No.: US 2007/0198217 A1
(43) Pub. Date: Aug. 23, 2007

(54) METHOD FOR DETERMINING A SYSTEM OPERATING STATE

(75) Inventor: Thomas Kattwinkel, Wildberg (DE)

Correspondence Address: DICKE, BILLIG & CZAJA, FIFTH STREET TOWERS, 100 SOUTH FIFTH STREET, SUITE 2250, MINNEAPOLIS, MN, 55402, US

(73) Assignee: INFINEON TECHNOLOGIES AG, Muenchen (DE)

(21) Appl. No.: 11/678,665

(22) Filed: Feb. 26, 2007

Related U.S. Application Data
(63) Continuation of application No. 10/802,412, filed on Mar. 17, 2004, now abandoned.

(30) Foreign Application Priority Data
Mar. 17, 2003 (DE) 103 11 903.5
Feb. 26, 2007 (DE) 103 25 746.2

(51) Int. Cl. G06F 17/40

(52) U.S. Cl. 702/183; 702/127; 702/182; 702/187; 702/189

(57) ABSTRACT

Provided is a method and an apparatus for detecting an operating state or a change in an operating state in a system in which at least one analog signal indicating the operating state is present. The method includes sampling of the analog signal or of a signal dependent on the analog signal for the purpose of providing a sampling signal. The method also includes generation of a transformation signal representing a spectral distribution from a number of signal values of the sampling signal, and comparison of the transformation signal with at least one reference signal representing a spectral distribution.

### CROSS-REFERENCE TO RELATED APPLICATIONS

This Utility Patent Application claims priority to German Patent Application No. DE 103 11 903.5, filed on Mar. 17, 2003, which is incorporated herein by reference.

### BACKGROUND

The present invention relates to a method for determining an operating state of a system in which at least one analog signal indicating the operating state is present.

A system of this type is, by way of example, a DC motor that in the case of a multiplicity of applications, it is necessary to detect the rotational speed and load state of said motor in order to be able to drive it in a suitable manner. Systems with DC motors requiring continual monitoring of the load state are electrical drives, by way of example, in which it is necessary to identify different load states in order to protect the drives and users, if appropriate, by shutting down the motor. For example, such load states in the case of which the motor is intended to be shut down are, in disturbance-free operation, the reaching of end positions of the drive and, in disturbance-beset operation, an increased friction due to wear or ambient influences or an obstacle introduced into the drive, for example a user's limbs. Such load states have to be reliably identified for protection of the operator and of the drive apparatus. Electrical drives are increasingly being incorporated into motor vehicles, in particular, which electrical drives are intended to be able to be produced simply and cost-effectively and are intended to function securely and reliably.

There are a multiplicity of different apparatuses for identifying the rotational speed and identifying the load state of an electric motor and also for determining the position of a shaft coupled to the motor.

Incremental encoders are widespread for identifying the angular position of a motor shaft, in the case of which incremental encoders a coding disc having markings is arranged on the motor shaft, which markings can be used to deduce the angular position of the shaft and also make it possible to determine the rotational speed of the shaft. However, such incremental encoders are complicated and cost-intensive to produce and require additional space directly at the motor or at the shaft.

Furthermore, it is known, for detecting the rotational speed of a motor, to use Hall sensors in conjunction with a rotor fitted on the motor shaft, the Hall sensors being arranged directly adjacent to the rotor and providing a sinusoidal voltage signal upon rotation of the shaft, it being possible to derive the rotational speed from the frequency of the voltage signal. What is problematic in this case is that the Hall sensor has to be mounted very near to the rotor in order to achieve a good magnetic coupling. Moreover, the measurement by means of such Hall sensors is complicated and cost-intensive. Furthermore, additional space is required directly at the motor or at the shaft, which in turn restricts the degrees of freedom in the installation of the motor.

A further possibility for determining the rotational speed of an electric motor is so-called “ripple counting”, which exploits the fact that the input current or a supply voltage of an electric motor which can be tapped off at the input terminals is subject to fluctuations whose frequency is dependent on the rotational speed and the number of windings of the motor. In this case, the number of amplitude peaks per unit time is evaluated in order thereby to be able to deduce the rotational speed. What is problematic in this case is that in addition to the motor, other loads which are connected to the same voltage source as the motor may also bring about fluctuations in the supply voltage of the motor and thus in the input current, which makes it more difficult to evaluate the current or voltage signal. One example of a voltage supply with a multiplicity of loads connected thereto is the on-board electrical power supply in a motor vehicle, motor vehicles increasingly making use of DC motors, for example for adjusting drives of any type, in addition to other electrical loads.

A further system whose operating state has to be permanently detected is, by way of example, an occupant protection system in a motor vehicle. Protection systems of this type, for example airbags or seat belt pretensioners, comprise pressure sensors that detect the pressure differences when an object collides with the vehicle or the vehicle collides with an object, in order thereby to trigger the occupant protection system. In this case, it is necessary to reliably unambiguously differentiate pressure fluctuations that indicate a serious impact from pressure fluctuations that arise as a result of an event which is harmless to the occupants, for example the impact of a football on one of the doors or a strong gust of wind.

### SUMMARY

One embodiment of the present invention provides a method and an apparatus for determining at least one operating state or for detecting a change in an operating state of a system in which at least one analog signal indicating the operating state is present, which can be implemented simply and in a cost-saving manner and which enables the operating state to be determined reliably.

The method according to one embodiment of the invention for detecting at least one operating state or a change in an operating state in a system in which at least one analog signal indicating the operating state is present comprises the sampling of the said analog signal or of a signal dependent on the said analog signal—and preferably generated by means of a filtering—for the purpose of providing a sampling signal and the generation of a transformation signal representing a spectral distribution from a number of signal values of the sampling signal. The said transformation signal is compared with at least one reference signal representing a spectral distribution.

In one embodiment, to determine the presence of a specific operating state, use is made of a reference signal which has been generated from an analog reference signal representing the said operating state and is thus assigned to the operating state to be determined. If the comparison reveals that the transformation signal has significant correspondences to the reference signal, then the operating state represented by the reference signal is present in the system. Preferably, the transformation signal is compared with a plurality of reference signals representing respectively different operating states, in order in this way to be able to distinguish between the different operating states of the system.

In one embodiment, to detect a temporal change in the operating state, use is made of a reference signal that corresponds to a previously generated transformation signal.

In one embodiment, the transformation signal and the at least one reference signal are discrete Fourier transforms that are generated by means of a fast Fourier transformation (FFT) from a number of samples of the analog signal representing the operating state, which analog signal is referred to hereinafter as analog system signal, and of the analog reference signal. As is known, a discrete Fourier transform comprises a number of spectral lines corresponding to the number of samples from which it is formed, it being possible to determine the load state from the distribution of the said spectral lines.

In one embodiment, the comparison of the discrete Fourier transforms of the analog system signal and of the reference signal, which likewise represents a Fourier transform and is referred to hereinafter as reference transform, comprises, by way of example, the formation of the magnitudes of the said Fourier transforms, the determination of the magnitudes of the differences of the individual spectral components and the summation of this magnitude difference. If the sum thereby determined lies below a reference value, then it is assumed that the Fourier transform of the analog system signal and the reference transform have such large correspondences that it is possible to assume a presence of the operating state represented by the reference transform.

Examining the analog system signal representing the operating state in the frequency domain instead of in the time domain affords the advantage that, by way of example, fluctuating offsets of the system signal do not play a part, or play only a very small part, in the determination of the operating state. The said offset only affects the amplitude of the spectral component representing the DC component in the discrete Fourier transformation, this spectral component not being taken into account for the comparison with the at least one reference transform since the remaining spectral components—not representing a DC component—are relevant for the determination of the operating state.

In addition to the above-explained consideration of the magnitudes of the Fourier transforms during the comparison of the Fourier transform of the system signal and the reference transform, it is also possible to compare the phases of these Fourier transforms with one another in order to determine whether the operating state represented by the reference signal is present. This evaluation of the phases may be effected as an alternative to the evaluation of the magnitudes or may be performed in addition to the evaluation of the magnitudes in order to obtain additional information and thereby to increase the reliability or the quality of the evaluation.

The method according to one embodiment of the invention for determining the operating state or for determining a change in an operating state in a system in which an analog system signal representing the operating state is present is suitable for determining the operating state of a DC motor having connecting terminals for the application of a supply voltage, the signal representing the operating state in the case of such a DC motor being a voltage present between the connecting terminals.

This exploits the fact that said voltage, given a constant rotational speed of the motor, is subject to periodic fluctuations, the period duration of one of these fluctuations or the frequency of the voltage which can be tapped off between the connecting terminals being dependent on the rotational speed of the motor and the number of lamellae of the commutator (number of pole pairs) of the motor. If this signal is sampled and the discrete Fourier transform is formed from a number of samples, then a spectral distribution is obtained in which the spectral line corresponding to the product of the rotation frequency of the motor and number of lamellae (number of pole pairs) of the motor is particularly pronounced. This spectral distribution changes if the rotational speed of the motor increases or decreases, by way of example, on account of changing load conditions of the motor. This change can be determined by comparison with corresponding reference transforms.

The reference transform may be a previously stored transform determined on the basis of series of experiments, by way of example, or the reference transform may be a transform which has been determined on the basis of preceding samples in order thereby to be able to identify a change in the instantaneous operating state relative to a previous operating state.

These two possibilities for providing a reference transform may be combined with one another.

In one embodiment, the signal present between the connecting terminals of the DC motor is subjected to a low-pass filtering before the sampling and formation of the Fourier transforms are carried out. In this case, the limiting frequency of the low-pass filter is chosen such that it is less than half the sampling frequency, in order thereby to avoid aliasing effects during the formation of the discrete Fourier transforms from the sample.

The evaluation of the discrete Fourier transform of the voltage present between the connecting terminals of the DC motor or the evaluation of the discrete Fourier transform of the low-pass filter voltage signal enables an evaluation of the load state of the DC motor with regard to its rotational speed, but does not enable a determination of the direction of rotation of the motor. Therefore, in one embodiment, provision is made for determining the voltages at both connecting terminals of the motor with respect to a reference-ground potential and for comparing the voltages determined with one another in order to deduce the direction of rotation of the motor therefrom. If these voltages are sampled and discrete Fourier transforms are formed from these samples, then it is possible, on the basis of a comparison of the said transforms with reference transforms, also to identify, by way of example, a braking operation during which the voltage supply of the motor is interrupted. Even the quality of relay contacts of a relay which connects the motor to a supply voltage or the load path resistances of transistors of an H bridge which connects the motor to a supply voltage can be evaluated by means of such a method in order thereby to detect, by way of example, possible wear phenomena during long-term operation of the motor.

One embodiment of the invention provides for the rotational speed of the motor to be determined directly from the voltage of the DC motor present at the connecting terminals or from the low-pass-filtered voltage signal and for the sampling frequency to be set in a manner dependent on the rotational speed determined. The rotational speed of the motor from the voltage present at the connecting terminals can be determined, for example, by determining the number of voltage spikes of the signal within a time interval and subsequently forming the quotient of the time interval and the number of voltage spikes determined.

The method according to one embodiment of the invention for determining the operating state of a system in which an analog signal representing the operating state is present is not restricted to the detection of the operating state or load state of a DC motor, but rather can be applied to any desired systems.

One example of a further system of this type is an occupant protection system in a motor vehicle. Such an occupant protection system comprises, by way of example, airbags or seatbelt pretensioner systems which are triggered in a manner dependent on a sensor signal. The sensor that provides this sensor signal is, by way of example, a pressure sensor arranged in a door cavity of the vehicle, the said pressure sensor serving to detect the pressure fluctuations resulting from an impact. In order to be able to differentiate the pressure fluctuations resulting from a serious impact from the pressure fluctuations in the event of a harmless impact, the operating state of such a system is detected by means of a method according to one embodiment of the invention by virtue of the fact that the sensor output signal is sampled, the discrete Fourier transform is formed from the samples and the Fourier transform formed is compared with at least one reference Fourier transform, the reference transform being chosen so as to represent a dangerous situation in order to be able to identify this critical situation on the basis of a comparison of the Fourier transform determined from the sensor signal and the said reference Fourier transform.

The apparatus according to one embodiment of the invention for determining the operating state of a system in which at least one analog system signal indicating the operating state is present comprises a sampling device for sampling the analog signal and providing a sampling signal, a transformation unit, to which the sampling signal is fed and which provides a transformation signal from a number of samples of the sampling signal, a comparator arrangement, to which the transformation signal is fed and which compares the transformation signal with at least one reference signal representing a spectral distribution in order to determine whether the operating state represented by the reference signal is present, and which provides a state signal dependent on the operating state determined.

In one embodiment, such an apparatus is used in a drive circuit for a DC motor having connecting terminals for the application of a supply voltage, a signal dependent on a voltage between the said connecting terminals being fed to the apparatus for determining the operating state.

### BRIEF DESCRIPTION OF THE DRAWINGS

The accompanying drawings are included to provide a further understanding of the present invention and are incorporated in and constitute a part of this specification. The drawings illustrate the embodiments of the present invention and together with the description serve to explain the principles of the invention. Other embodiments of the present invention and many of the intended advantages of the present invention will be readily appreciated as they become better understood by reference to the following detailed description. The elements of the drawings are not necessarily to scale relative to each other. Like reference numerals designate corresponding similar parts.

FIG. 1 illustrates a block diagram of an apparatus for determining the operating state of a system on the basis of an analog system signal which occurs in the system.

FIG. 2a illustrates an exemplary temporal profile of an analog system signal representing the operating state and the samples obtained from this signal.

FIG. 2b illustrates an example of a discrete Fourier transform from N samples.

FIG. 3 illustrates an exemplary embodiment of a comparator unit which compares a Fourier transform determined from the system signal with a reference Fourier transform and provides an operating state signal.

FIG. 4 illustrates an exemplary embodiment of the unit illustrated in FIG. 3 within the comparator unit which provides the operating state signal.

FIG. 5 illustrates a circuit arrangement with a DC motor and an apparatus for determining the operating state of the DC motor.

FIG. 6 illustrates a circuit arrangement with a DC motor and an apparatus for determining the direction of rotation of the DC motor.

FIG. 7 illustrates a circuit arrangement with a DC motor driven by a full bridge circuit and with a circuit arrangement for providing an analog system signal representing the operating state of the motor.

FIG. 8 illustrates an exemplary temporal profile of an analog signal representing the operating state in the case of a DC motor.

FIGS. 9a-9b illustrate a block diagram of an apparatus for setting the sampling frequency in a manner dependent on the analog signal.

FIG. 10 illustrates a block diagram of an exemplary embodiment of a unit for generating the discrete Fourier transform of a sampling signal and a unit for generating the sampling signal from the system signal.

FIGS. 11a-c illustrate an illustration of a possible method for determining the period duration of the analog signal.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

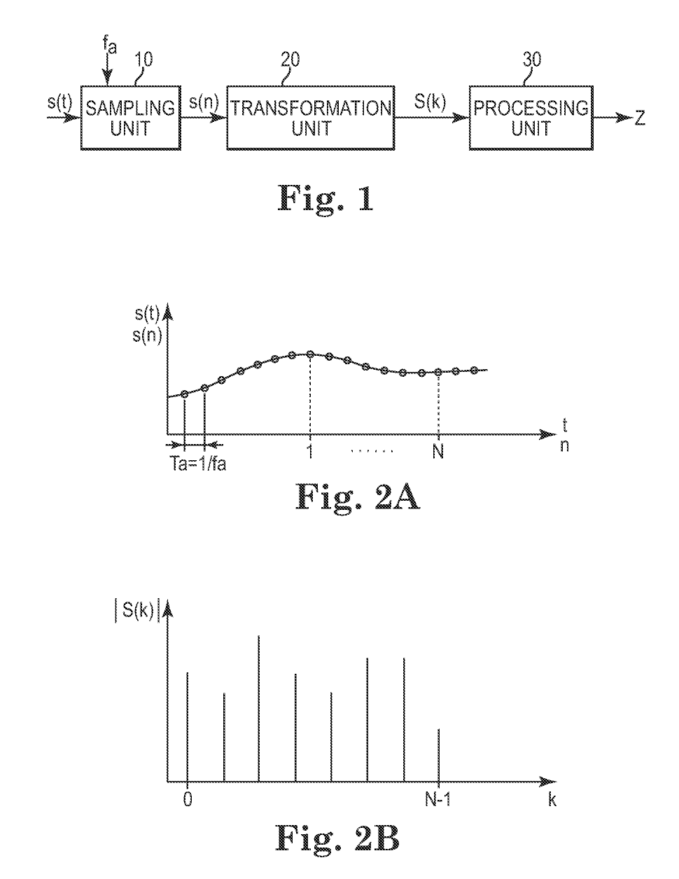

FIG. 1 illustrates the block diagram of an apparatus for providing a state signal Z—dependent on an operating state of a system—from an analog signal s(t) representing the operating state of the system (not specifically illustrated), which analog signal is referred to hereinafter as system signal. The apparatus comprises a sampling unit 10, which samples the system signal s(t) at a sampling frequency fa and provides a sampling signal s(n). This sampling signal s(n) is fed to a transformation unit 20, which provides a transformation signal s(k) from a number of samples of the sampling signal s(n), the said transformation signal preferably representing the discrete Fourier transform (DFT) of the sampling signal s(n). The sampling frequency and the number of samples used to form the DFT are adjustable, as will be explained. In principle, there are two possibilities for determining the DFT, which depend in particular on the available performance of the processing unit 30 used, said processing unit usually being designed as a microcontroller.

Firstly, there is the possibility of determining the DFT once after N sampling steps for the N samples, where N is 128, 256 or 1024, by way of example, and then of evaluating the DFT.

Secondly, there is the possibility of determining the DFT after each sample for this sample and the N−1 previous samples, or of determining the DFT after in each case M samples, where M<N, for in each case N samples.

FIG. 2a illustrates, by way of example, a detail from the temporal profile of the system signal s(t) and the samples s(n) determined by sampling said sampling signal s(t) at the sampling frequency fa.

FIG. 2b illustrates, by way of example, the magnitude of a discrete Fourier transform s(k) formed from N samples of the sampling signal s(n). As is known, the discrete Fourier transform formed from N samples comprises N spectral lines, the spectral lines at 0 representing the DC component of the system signal s(t) and the remaining spectral lines representing spectral components of the system signal s(t) in each case at fractions of the sampling frequency fa. Thus, the spectral line at N−1, by way of example, represents the spectral component of the system signal s(t) with the frequency (N−1)/N·fa. The discrete Fourier transform is generated from the N samples in a sufficiently known manner in accordance with the following equation:

$$S ( k ) = {\sum }_{n = 0}^{N - 1} s ( n ) \cdot {ⅇ}^{- j ( 2 π / N ) \cdot k \cdot n} for K = 0 … N - 1$$

The generation of the discrete Fourier transform s(k) in the transformation unit 20 is effected using a fast Fourier transformation (FFT). Methods for such fast Fourier transformations are described in detail in Oppenheim, Schafer: “Zeitdiskrete Signalverarbeitung” [“Time-discrete signal processing”], Oldenburg-Verlag, Munich, 1992, on pages 661 to 714.

The discrete Fourier transform S(k) generated from the system signal s(t), which is referred to hereinafter as system signal transform, is fed to a comparator unit 30, in which the said system signal transform S(k) is compared with at least one reference Fourier transform in order to generate the state signal Z on the basis of this comparison. The at least one reference Fourier transform is formed using a discrete Fourier transformation from an analog signal that represents an operating state to be detected. If the comparison of the discrete Fourier transform S(k) determined from the system signal and the reference Fourier transform reveals that the system signal transform S(k) corresponds to the reference Fourier transform, then the operating state represented by the reference Fourier transform is present in the system and a corresponding state signal Z is output.

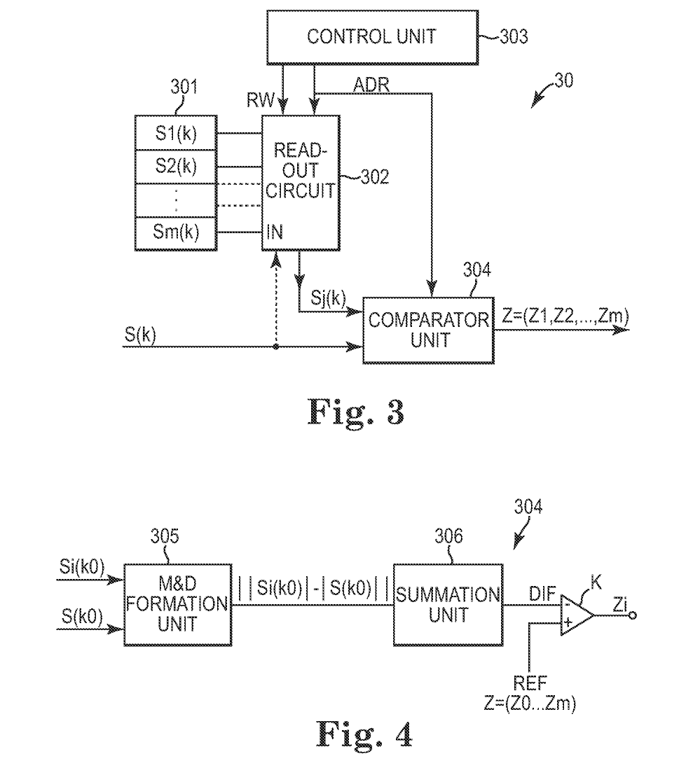

FIG. 3 illustrates, by way of example, the construction of a comparator unit 30 which compares the system signal transform S(k) with a reference transform and provides a state signal in a manner dependent on the comparison result, in a block illustration. The comparator unit 30 comprises a memory unit 301, in which a plurality of reference Fourier transforms S1(k), S2(k), Sm(k) are stored. Connected to the memory unit 301 is a read-out circuit 302, which is designed to read out an Si(k) of the reference Fourier transforms S1(k), S2(k), Sm(k) from one of the memory locations of the memory unit 301 according to an addressing signal ADR supplied by a control unit 303 and to feed this one reference Fourier transform Si(k) to a comparator unit 304. The comparator unit 304 is designed to compare each of the reference Fourier transforms S1(k), S2(k), Sm(k) with the system signal transform S(k) and to provide the state signal Z in a manner dependent on these comparison results.

The reference transforms are either chosen such that they correspond to operating states to be detected in order, on the basis of a correspondence between the present transform and a reference transform, to be able to identify the state assigned to the said reference transform. As an alternative or in addition, the reference transforms may also be chosen such that they correspond to previously determined transforms in order to be able to identify changes in the operating state on the basis of deviations between the instantaneous transform and the earlier transform.

In one embodiment, the state signal Z is a vector having vector elements Z1, Z2, . . . , Zm, the individual vector elements of which in each case represent the comparison result between one of the reference Fourier transforms S1(k), S2(k), Sm(k) and the system signal transform S(k). The comparator unit 304 is fed the address signal ADR in order to inform the comparator unit 304 of which of the reference Fourier transforms stored in the memory unit 301 is currently present at the input of the comparator unit 304 and which vector element Zi of the state signal Z is currently formed depending on the comparison of this reference Fourier transform Si(k) with the system signal transform S(k).

In one embodiment, the control unit 303 supplies a write/read signal to the circuit 302, which is designed, depending on this signal, to read out the value from the memory position prescribed by the address signal or to write a value which is present at an input IN to the said memory position. Reference transforms can then be generated and stored in a simple manner by means of the arrangement illustrated in FIGS. 2 and 3 by a reference signal being applied to the sampling circuit instead of the sampling signal s(t), the said reference signal representing a specific operating state, and by the resultant reference transform which is present at the output of the transformation unit 20 being written to a selected memory position of the memory 301. It is furthermore possible to store transforms S(k) in the memory 302 in order to detect operating state changes at regular time intervals.

FIG. 4 illustrates the block diagram of an exemplary embodiment of the comparator unit 304 illustrated in FIG. 3. In the example, this comparator unit 304 comprises a magnitude and difference formation unit 305, which is fed the system signal transform S(k) and one Si(k) of the reference Fourier transforms stored in the memory unit 302 (FIG. 3). As already explained with reference to FIG. 2, the system signal transform S(k) and the reference Fourier transform Si(k) comprise a number of signal values corresponding to the number of samples N, S(k0) and Si(k0), respectively representing one of these signal values in FIG. 4. The magnitude and difference formation unit 305 forms the magnitudes of the individual, usually complex-valued signal components S(k0), Si(k0) of the Fourier transforms S(k), Si(k), forms the difference of these magnitudes and outputs, at the output, the magnitude of these differences determined. Connected downstream of the magnitude and difference formation unit 305 is a summation unit 306, which sums the N individual magnitude differences and outputs a difference signal DIF. This difference signal is compared with a reference signal REF by means of a comparator k in order to output a state value Zi, in the example this state value Zi being equal to one if the difference value DIF is less than a predetermined reference value REF. Depending on the reference signal used, the state value Zi can then be used to identify whether a specific operating state is present or whether a change has occurred relative to an earlier operating state.

The method elucidated by means of a comparator unit 304 in accordance with FIG. 4 corresponds to the determination of the distance between the magnitude of the Fourier transform S(k) resulting from the system signal s(t) and the reference Fourier transform Si(k), the state value Zi being generated in a manner dependent on whether the distance is greater or less than the reference value REF, it being assumed that the operating state that has resulted by virtue of the reference Fourier transform Si(k) is present if the distance between the Fourier transform S(k) of the system signal s(t) and the reference Fourier transform is less than the reference value REF. Any desired further methods for determining a distance value and for determining a state signal from the distance value can be employed in connection with the invention.

The method explained previously is suitable for determining the load state of a DC motor M, as is explained below.

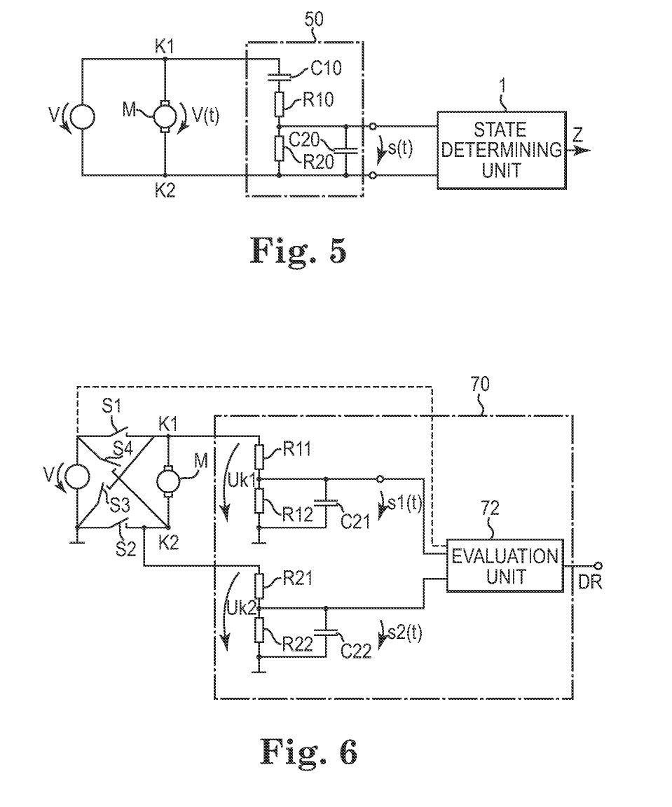

FIG. 5 illustrates a circuit arrangement with a DC motor M having connecting terminals K1, K2 for the application of a DC voltage supplied by a supply voltage source V. A motor voltage v(t) can be tapped off between the connecting terminals K1, K2, which motor voltage is subject to periodic fluctuations in a known manner, the frequency or period duration of these fluctuations being dependent on the rotational speed of the motor and the number of pole pairs of the motor. The motor voltage v(t) represents an analog signal representing the operating state or load state of the motor. The circuit arrangement furthermore comprises a low-pass filter arrangement 50 having a first capacitor C10 and first and second resistors R10, R20, which are connected in series between the connecting terminals K1, K2. A second capacitor C20 is connected in parallel with the second resistor R20, a low-pass-filtered signal s(t) being present across the parallel circuit formed by the second resistor R20 and the capacitor C20, which signal likewise represents a signal representing the load state of the motor M and is fed to a state determining unit 1 in order to determine a state signal Z.

This state determining unit 1 performs the previously explained method for determining the state signal Z and is constructed for example in accordance with the apparatus explained with reference to the previous FIGS. 1, 3 and 4.

The evaluation of the motor voltage v(t) or of the low-pass-filtered signal s(t) dependent thereon makes it possible, with the use of suitable reference Fourier transforms, to determine the load state of the motor M, in particular to determine the rotational speed thereof and also to determine age-dictated wear and tear phenomena.

In order also to determine the direction of rotation of the motor in addition to the said load state, provision is made, referring to FIG. 6, for determining the voltage at both motor connecting terminals K1, K2 in each case with respect to a reference-ground potential GND and for determining, from the ratio of these voltages, the polarity of the voltage supply source V1 and thus the direction of rotation of the motor M. In one embodiment, a rotational speed determining unit 70 that fulfils this function comprises two identically constructed circuit branches, of which one is connected to the first connecting terminal K1 and the other is connected to the second connecting terminal K2. Each of the circuit branches comprises a low-pass filter R11, R12, C21 and, respectively, R12, R22, C22, which in each case provide a low-pass-filtered voltage signal s1(t), s2(t) with respect to reference-ground potential. These low-pass-filtered signals s1(t), s2(t) are fed to analog inputs of an evaluation unit 72, which is designed as a microcontroller, for example, which determines the direction of rotation of the motor from the ratio of the signals s1(t), s2(t) and which is furthermore also able to detect a braking operation in which the supply voltage V is turned off. The analog signals s1(t), s2(t) are sampled in the evaluation unit 72 before the further processing thereof, it being possible to identify the direction of rotation in each case on the basis of a sample of the first signal s1(t) and a sample of the second signal s2(t). In this case, if the first signal s1(t) is greater than reference-ground potential GND and the second signal s2(t) corresponds to the reference-ground potential, that is, the first terminal K1 is connected to the positive supply connection of the voltage source V, then a first direction of rotation is identified. Conversely, a second direction of rotation is identified if the first signal s1(t) is at reference-ground potential and the second signal lies above reference-ground potential GND. If both signals s1(t), s2(t) are at reference-ground potential, then a braking operation of the motor is identified.

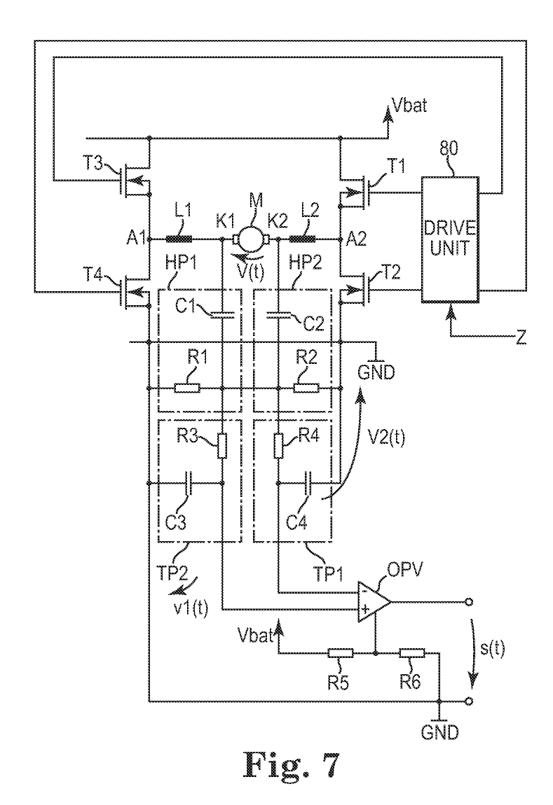

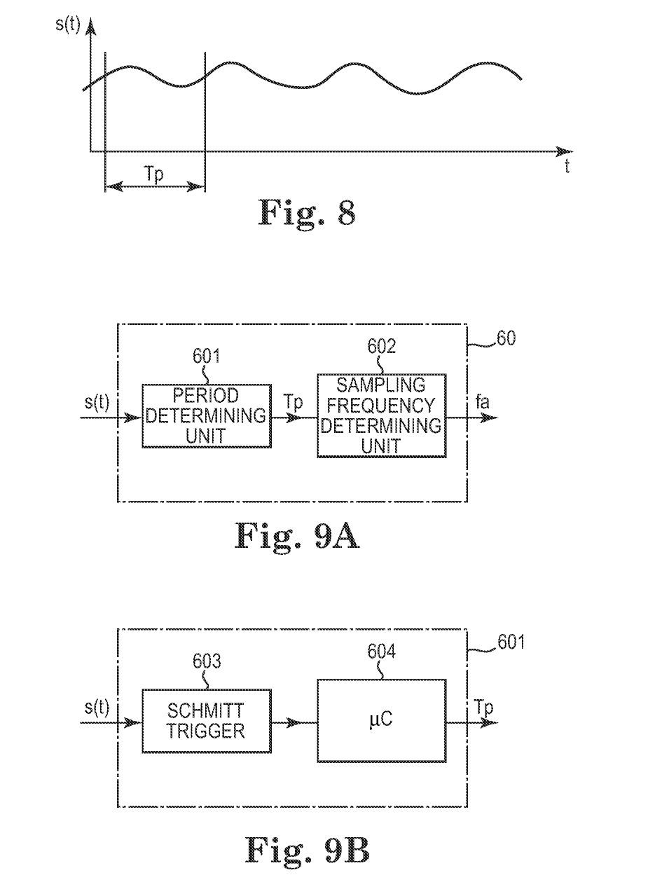

Moreover, the evaluation unit is optionally able to determine wear phenomena, for example at a relay S1, S2, S3, S4 connecting the supply voltage V1 to the motor, which relay is illustrated diagrammatically as an arrangement comprising four switches in FIG. 6, or an H bridge connecting the motor to the supply voltage, as is illustrated by way of example in FIG. 7. The evaluation unit is also fed, in addition to the first and second analog signal, the supply voltage V1 in order to be able to determine the voltage dropped across the switches S1,S2, S3, S4, and thus the wear thereof, by way of the ratio of the voltages at the first and second terminals, that is, the first and second signals s1(t), s2(t) and the supply voltage. This procedure is briefly explained below using an example.

It shall be assumed that the switches S1, S2, S3, S4 are switched such that the positive supply potential of the voltage source is connected to the second terminal via the switch S4 and the reference-ground potential GND is connected to the first terminal K1 via the switch S3. In this case, the potentials at the first and second terminals K1, K2 deviate from reference-ground potential and supply potential V1, respectively, to a greater extent the higher the voltage drop across the switches S3, S4 and thus the wear thereof. In order to determine the voltage drop across the switches, it is possible to use the first and second analog signals s1(t), s2(t), in which case it has to be taken into account that the signals s1(t) is related by way of the voltage divider ratio of the divider R11, R12 to the voltage Uk1 at the first terminal K1 with respect to reference-ground potential GND and the signal s2(t) is related by way of the divider ratio of the divider R21, R22 to the voltage at the second terminal Uk2 with respect to reference-ground potential. In the evaluation circuit, with knowledge of the said divider ratios, the instantaneous values of the terminal voltages Uk1, Uk2 are determined from the samples of the signals s1(t), s2(t) and compared with stored value intervals. In this case, if the first terminal voltage Uk1 lies within a first interval, for which the following holds true: 0≦Uk1≦0.5 V, then the contacts of the switches or relays are regarded as in tact. If the voltage lies within a second interval for which the following holds true, by way of example: 0.5≦Uk1≦0.75 V, then increased standard values are assumed in the case of which, however, a function is still ensured, while a functionality of the switches which is no longer permanently ensured is assumed if the terminal voltage lies in or above an interval for which the following holds true: 0.5≦Uk1≦0.75 V. The wear information obtained by the comparison of the terminal voltage Uk1 may for example be stored in a memory, such as an EEPROM, and be read out by a user. A corresponding procedure is effected for determining the wear of the remaining switches, it being necessary here to take account of the supply voltage and the following holding true for the comparison intervals corresponding to the above intervals taken into account in the evaluation of the terminal voltage Uk1: V1−0.5V≦Uk2≦V1, V1−0.75V≦Uk2≦V1−0.5V, V1−1V≦Uk2≦V1−0.75V. A functionality that is not permanently ensured is assumed in this case when the terminal voltage Uk2 deviates from the supply voltage V1 by more than =0.75 V. The values which are used for determining wear and which serve for determining the voltage drop across the switches are chosen in a manner dependent on the concrete switching elements and are to be chosen differently in the case of semiconductor switches, for example MOSFETs, than in the case of mechanical switches, for example, relays.

FIG. 7 illustrates a further circuit arrangement with a motor M and a drive circuit for the motor M, the drive circuit having a full bridge circuit or an H bridge with four MOSFETs T1, T2, T3, T4, which are driven by a drive circuit 50. The motor M is connected in series with a first and second coil L1, L2 between the connections A1, A2 of the full bridge circuit. The MOSFETs T1-T4 of the full bridge circuit are driven in pulse-width-modulated fashion by the drive circuit 50, it being possible to regulate the power consumption of the motor by means of the duty cycle of the MOSFETs. The inductances L1, L2, which are connected in series with the motor M, serve for interference suppression during the switching operations of the MOSFETs.

A circuit arrangement that provides a signal s(t), which is dependent on the motor voltage v(t) and likewise represents the load state, comprises an operational amplifier OPV, the input terminals of which are coupled to the motor terminals K1, K2. In each case identically constructed filter arrangements are connected between the inputs of the said operational amplifier OPV and the motor connecting terminals K1, K2, which filter arrangements in each case have a high-pass filter HP1, HP2 comprising a capacitor C1, C2 and a resistor R1, R2 and a low-pass filter TP1, TP2 comprising a resistor R3, R4 and a capacitor C3, C4, said low-pass filter being connected downstream of the high-pass filter HP1, HP2. The filters provide filter output signals v1(t), v2(t) which are in each case referred to reference-ground potential GND and are fed to the operational amplifier OPV. In this case, the high-pass filters HP1, HP2 serve for filtering out the DC component from the voltages present between the motor connecting terminals K1, K2 and reference-ground potential GND, and the low-pass filters TP1, TP2 connected downstream of the high-pass filters HP1, HP2 serve for band limiting for the subsequent sampling of the system signal s(t). The low-pass filters TP1, TP2 also eliminate high-frequency interference components which result from the clocked driving of the MOSFETs T1-T4.

The temporal profile of this system signal s(t) which results from the motor voltage V(t) and is used for determining the load state is illustrated by way of example in FIG. 8. The periodic fluctuations of this signal s(t), the period duration Tp of which is dependent on the rotational speed of the motor and the number of pole pairs of the motor, are clearly discernable in FIG. 8. The sampling frequency for the subsequent sampling of this system signal s(t) is dependent on the said period duration Tp, the sampling frequency being chosen and coordinated with the number of samples N to be determined for the formation of the Fourier transforms such that the N samples are determined in a time window which is larger than the period duration Tp.

FIG. 9a shows an apparatus for determining the sampling frequency fa from the system signal s(t) in a block diagram. The apparatus 60 comprises a unit for determining the period duration Tp of the said system signal s(t). The period duration Tp provided by the period duration determining unit 601 is fed to a sampling frequency determining unit 602, which uses the period duration Tp determined to determine the sampling frequency fa, which is fed to the sampling unit (FIG. 1). FIG. 11 illustrates a possible method for the determination of the period duration Tp by the period duration determining unit 601. FIG. 11a shows the temporal profile of the input signal s(t) and also a decision threshold of a Schmitt trigger which is present in the period duration determining unit 601 and provides the output signal illustrated in FIG. 11b, this signal having a high level if the signal s(t) lies above the threshold and having a low level if the signal s(t) lies below the switching threshold of the Schmitt trigger. In this case, the period duration determining unit 601 contains a timer, the timer value of which is illustrated in FIG. 11c by way of example against time t. The value of the timer is determined with each rising edge of the signal of the Schmitt trigger, in the example a timer value A being present at the instant t and a timer value B being present at the instant t2 of the subsequent rising edge of the Schmitt trigger signal. With knowledge of the clock frequency with which the timer is incremented, the difference B−A between these timer values is used to determine the temporal distance between the instants t1 and t2, and thus the period duration Tp.

The apparatus 60 comprises, by way of example, a microcontroller having an interrupt input, which is fed the previously explained Schmitt trigger signal illustrated in FIG. 11b. The respective counter readings of the timer are read out according to the interrupts generated by the Schmitt trigger signal. Such a realization of the unit 601 by means of a Schmitt trigger 603 and a microcontroller 604 is illustrated diagrammatically in FIG. 9b.

The sampling frequency determining unit 602 is designed to generate the sampling frequency fa such that an identical number of samples are determined within the period duration Tp determined by the period duration determining unit 601. If N is the number of samples to be determined within a period duration Tp, then the following holds true for the sampling frequency fa:
fa=1/(Tp·N).

The number of samples to be generated is set in a manner dependent on the period duration Tp in order, by way of example, to generate more samples in the case of longer period durations Tp. In one embodiment, the number of samples between which a selection may be made is multiples of 2, it generally holding true that the quality of the method is better, the more samples are determined per period of the signal. In one embodiment, at least 128 samples are determined per period duration Tp. 256, 512 or 1024 or even more sampling instants per period duration are better.

A decision threshold of the Schmitt trigger 603 may be generated for example by forming the average value of preceding samples of the analog signal s(t), the average value of a predetermined number of samples determined last being formed, by way of example.

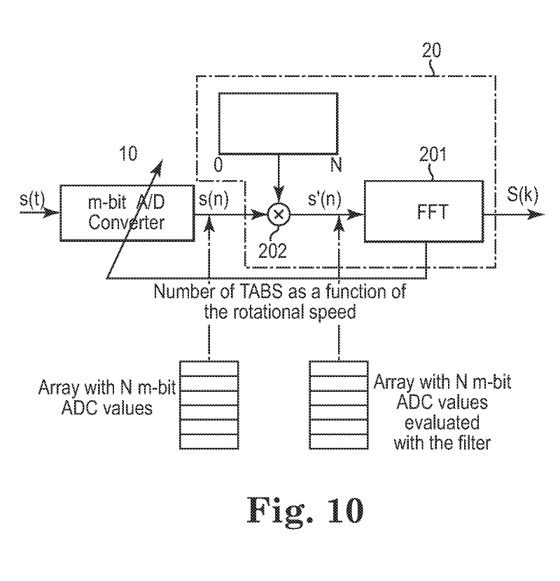

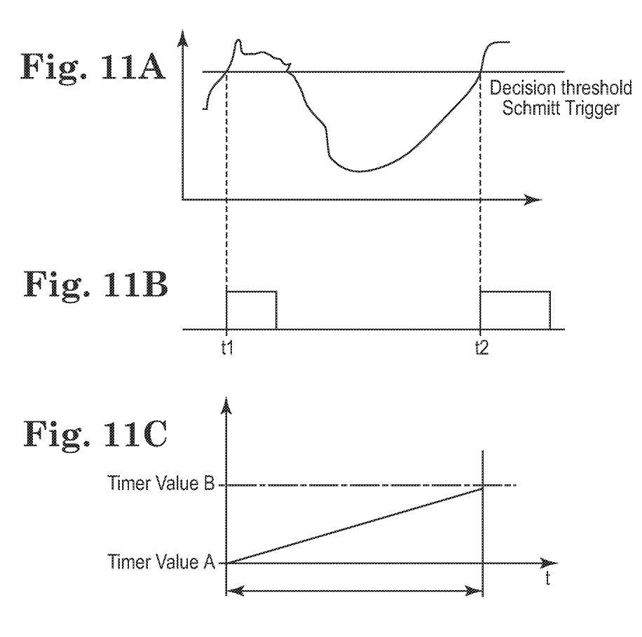

FIG. 10 illustrates an exemplary embodiment of the transformation unit 20, which provides the discrete Fourier transform S(k) from the sampling signal s(n). This transformation unit 20 comprises a unit 201 for calculating the discrete Fourier transform S(k) from weighted samples s′(n), the weighted samples s′(n) resulting from a weighting of the samples s(n). The weighting is effected for example in such a way that the N samples from which the discrete Fourier transform S(k) is formed are weighted for example using a so-called hamming window, which weights the values at the start and at the end of the sequence comprising N samples to a lesser extent than the values in the centre of the sampling sequence.

The sampling unit 10 in one embodiment comprises a digital-to-analog converter, so that N samples which in each case have a word width of m bits are fed to the transformation unit 20 in order to form a discrete Fourier transform. The discrete Fourier transform provided at the output of the transformation unit 20 correspondingly comprises N spectral components, 2·N values being output for taking account of the real part and the imaginary part of the discrete Fourier transform.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

1.-26. (canceled)

27. A method for detecting an operating state or a change in an operating state of a DC motor having connecting terminals for the application of a supply voltage, with a voltage present between the connecting terminals being an analog signal indicating the operating state of the motor the method comprising:
sampling the analog signal or a signal dependent on the analog signal for providing a sampling signal;
generating a transformation signal representing a spectral distribution from a number of signal values of the sampling signal; and
comparing the transformation signal with at least one reference signal representing a spectral distribution.

28. The method of claim 27, wherein the at least one reference signal has been generated from an analog reference signal representing an operating state to be detected.

29. The method of claim 27, wherein the at least one reference signal is a transformation signal generated on the basis of previous samples.

30. The method of claim 27, wherein the transformation signal and the at least one reference signal are discrete Fourier transforms.

31. The method of claim 30, wherein the discrete Fourier transforms are generated by means of a fast Fourier transformation.

32. The method of claim 27, wherein the sampling signal is band-limited before the transformation signal is generated.

33. The method of claim 27, wherein the transformation signal is compared with a plurality of reference signals.

34. The method of claim 27, wherein the samples used to form the transformation signal are subjected to a weighting before the formation of the transformation signal and wherein weighting at least two of the samples are weighted differently.

35. The method of claim 31, wherein the magnitudes of the discrete Fourier transforms of the sampling signal and of the at least one reference signal are compared with one another.

36. The method of claim 35, wherein a state represented by the at least one reference signal is assumed to be present if the sum of the magnitudes of the differences of the individual spectral components of the discrete Fourier transforms of the sampling signal and of the at least one reference signal is less than a reference value.

37. The method of claim 36, wherein the phases of the Fourier transforms of the sampling signal and of the reference signal are also compared with one another.

38. The method according to claim 27, wherein a sampling frequency is set depending on a determined period duration of the analog signal such that the number of samples determined per period of the signal corresponds to a predetermined number.

39. The method of claim 38, wherein the period duration is determined by a comparison of the analog signal with a predetermined threshold value.

40. The method of claim 39, wherein the threshold value is generated by an averaging of the analog signal.

41. The method of claim 40, wherein the voltage present between the connecting terminals is subjected to a low-pass filtering and the transformation signal is formed from the signal resulting from the low-pass filtering.

42. The method of claim 40, wherein a voltage is determined at both connecting terminals with respect to a reference-ground potential and the voltages determined are compared with one another in order to determine a direction of rotation of the motor.

43. The method of claim 42, wherein the rotational speed of the motor is determined directly from the voltage present at the connecting terminals, and in which the sampling frequency is set in a manner dependent on the rotational speed determined.

44. The method of claim 27, wherein 128 samples of the sampling signal are used to form the transformation signal.

45. The method of claim 40 for determining the operating state of an occupant protection system in a motor vehicle, the analog signal being a signal provided by a sensor.

46. The method of claim 45, wherein the sensor is a pressure sensor.

47. An apparatus for detecting an operating state or for detecting a change in the operating state of a DC motor having connecting terminals for the application of a supply voltage, with a voltage present between the connecting terminals being an analog signal indicating the operating state of the motor, the apparatus comprising:
a sampling device for sampling the analog signal and providing a sampling signal;
a transformation unit to which the sampling signal is fed and which provides a transformation signal for a number of samples of the sampling signal; and
a comparator arrangement to which the transformation signal is fed and which compares the transformation signal with at least one reference transformation signal representing a spectral distribution and which provides a state signal.

48. The apparatus of claim 47, wherein the at least one reference signal has been generated from an analog reference signal representing an operating state to be detected.

49. The apparatus of claim 48, wherein the at least one reference signal is a transformation signal generated on the basis of previous samples.

50. The drive circuit of claim 48, which has a direction of rotation detection unit, which is connected to the connecting terminals and which determines the potentials at the two terminals with respect to a reference-ground potential and, on the basis of a comparison of the potentials, provides a signal indicating the direction of rotation.
